(19) United States
(12) Patent Application Publication
(10) Pub. No.: US 2017/0050058 A1
(43) Pub. Date: Feb. 23, 2017

(54) Mouthheld filter apparatus

(71) Applicants: Stephen P. Konrad, Leonardo, NJ (US); Susan M. Rhone, Leonardo, NJ (US)

(72) Inventors: Stephen P. Konrad, Leonardo, NJ (US); Susan M. Rhone, Leonardo, NJ (US)

(21) Appl. No.: 15/330,166

(22) Filed: Aug. 17, 2016

Related U.S. Application Data
(60) Provisional application No. 62/205,981, filed on Aug. 17, 2015.

(51) Int. Cl. A62B 23/02; B01D 53/04; A62B 9/04; A62B 9/06; A62B 9/02; B01D 46/00; B01D 53/26

(52) U.S. Cl. CPC A62B 23/02; B01D 46/0005; B01D 53/04; B01D 53/26; B01D 46/0032; A62B 9/06; A62B 9/02; A62B 9/04; B01D 2253/102; B01D 2259/4541

(57) ABSTRACT

A mouthheld filter is provided that includes a mouth piece, a valve tube structure and a filter housing. The mouthpiece has a curvilinear mouth shield and bite wings for insertion into a user's mouth and maintenance of a secure position therein. The valve tube structure has a pair of one-way filters to properly direct the air inhaled and exhaled by the user. The filter housing contains either one or both of a particulate filter material within the filter housing and a filter material around a surface of the filter housing. Air inhaled by the user passes through the filter housing and filter material, into the valve tube structure and mouthpiece, and into the user's lungs. Air exhaled by the user passes through the mouth piece, the valve tube structure and out at least one exhaust tube coupled to the valve tube structure and into the environment.

### CROSS-REFERENCE TO RELATED APPLICATIONS

This application claims priority to and benefit of U.S. Provisional Patent Application No. 62/205,981 filed Aug. 17, 2015 titled “KONRAD BREATHING APPARATUS” the contents of which are incorporated by reference herein in its entirety.

### COPYRIGHT & TRADEMARK/TRADENAME NOTICES

A portion of the disclosure of this patent document may contain material, which is subject to copyright protection. The owner has no objection to the facsimile reproduction of any one of the patent document(s) or the patent disclosure, as it appears in the Patent and Trademark Office patent file or records, but otherwise reserves all copyrights whatsoever.

### BACKGROUND OF THE INVENTION

### 1. Field of the Invention

The invention relates to a filter apparatus, held in the mouth of a user, for filtering the air inhaled by the user. In essence the mouthheld filter forces all air inhaled through the mouth of a user to pass through a filter housing. The filter housing includes a filter that is one or both of a filter material contained within the housing and a filter sheath that surrounds a surface of the filter housing. The mouthheld filter includes a mouthpiece and a valve tube structure such that all the inhaled air is filtered by the filter housing which then passes through the valve tube structure, the mouthpiece and into the user's mouth and lungs. On exhale, the air passes through the mouthpiece, the valve tube structure and out a pair of exhaust tubes into the environment. A pair of one-way valves within the valve tube structure and the exhaust tubes provide for the proper directional airflow within the mouthheld filter. Finally, a nose clip may be combined with the mouthheld filter to force the user to employ only his mouth for breathing.

### 2. Description of Related Art

Prior art systems have been designed to address a host of problems in which respirators and emergency breathing systems are used to address dangerous environmental circumstances. One such disposable escape only mouthpiece respirator is offered by the 3M Corporation; the very expensive 5600 Series Mouthpiece Respirator. This system is described in the Technical Datasheet and User Instructions provided in the IDS in connection with the filing of this patent application. The 5600 Series Mouthpiece Respirator comprises a mouthpiece and a grill component. While an exhalation valve is indicated as being a part of the system, the system does not employ a dual valve system (one each for inhalation and exhalation) and it is not clear that exhalation is forced out into the environment.

In another prior art reference, U.S. Pat. No. 5,315,987, having inventor Swann (hereinafter “Swann I”), a filtering canister with deployable hood and mouthpiece is disclosed in which a large canister is provided that contains layers of filter material. (Abstract) A mouthpiece carrying a nose clip, inhalation and exhalation check valves and a whistle is disposed within a flexible, substantially transparent, hear-through hood. In use, the hood is drawn over the user's head and inhaled air passes through the canister where it is filtered and exhaled into the hood. The hood is attached to the mask and surrounds the individual's head thereby receiving exhaled air so as to maintain the interior hood pressure above the pressure of the air surrounding the hood. (Abstract.) Thus, the exhaled air does not vent to the outside environment through exhaust tubes and separate exhale valve structures contained therein, as in the present invention, and the exhaled air is not discarded so as to be eliminated from the user's breathing vicinity.

In another prior art reference, U.S. Pat. Appln. Pub. No. US2003/0234016, having inventor Swann (hereinafter “Swann II”), a personal emergency breathing system is disclosed containing an elastic, non-porous body housed within an outer protective shell. (Abstract) An air filter is disposed in the body and a mouthpiece, including a bite block, is provided for communicating filtered air into the individual user's mouth. As with Swann I, a hood attached to the mask surrounds the individual's head and receives exhaled air so as to maintain the interior hood pressure above the pressure of the air surrounding the hood. (Abstract and para.).

Thus, again, the exhaled air does not vent to the outside environment through exhaust tubes and separate exhale valve structures contained therein, as in the present invention, and the exhaled air is not discarded so as to be eliminated from the user's breathing vicinity.

Thus, the need exists in the art for a small, inexpensive, easily manufactured, reusable mouthheld filter that effectively filters all air inhaled by the user and returns the exhaled air to the surrounding environment so as to not further affect the user.

### BRIEF SUMMARY OF THE INVENTION

The objects and features of the present invention may be applied jointly or severally in any combination or sub-combination by those skilled in the art.

In one embodiment of the present invention, a filter for use by a user is provided and includes: a mouthpiece for insertion into the user's mouth, the mouthpiece having a curvilinear mouthpiece shield including at least one mouthpiece hole and an exterior mouthpiece tube coupled to the mouthpiece, the mouthpiece tube having proximal and distal ends with respect to the user, the proximal end of the mouthpiece tube coupled to the mouthpiece shield around the mouthpiece hole so as to permit air to flow through the mouthpiece hole and the mouthpiece tube; a valve tube structure having proximal and distal ends with respect to the user, the proximal end of the valve tube structure coupled to the distal end of the mouthpiece tube, the valve tube structure having a one-way valve within the tube so as to permit the flow of air into the valve tube structure from the distal end to the proximal end, the valve tube structure having an exhaust tube coupled to the valve tube structure and disposed between the one-way valve and the proximal end of the valve tube structure, the exhaust tube having proximal and distal ends with respect to the valve tube structure, the distal end of the exhaust valve exposed to the user's environment, the exhaust tube having a one-way valve within the exhaust tube so as to permit the flow of air out to the user's environment from the proximal end of the exhaust tube structure to the distal end of the exhaust tube; and a filter housing having a connection surface and a filter surface, the connection surface having a connection hole, the connection hole coupled to the distal end of the valve tube structure, the filter surface having at least one filter hole, the filter hole permitting air to flow from the filter hole to the connection hole and into the valve tube structure, the filter housing supporting a filter material, the filter material covering the filter hole and exposed to the user's environment.

In particular variations of this embodiment, the filter material is a cloth-like sheath, the filter material being affixed around an outside lateral surface of the filter housing; or the cloth-like sheath is a high efficiency particulate arresting filter; or the filter housing includes a first filter portion containing the connection surface and a second filter portion containing the filter surface; or the second filter portion is removable from the first filter portion, the second filter portion being removed to replace the filter material; or the exhaust tube is proximate to the proximate end of the valve tube structure and the one-way valve within the valve tube structure is proximate to the exhaust tube; or the valve tube structure includes a plurality of the exhaust tubes, each disposed between the on-way valve and the proximal end of the valve tube structure; or the valve tube structure includes at least one flange containing a hole, the flange and hole used for securing one of a cap, a nosepiece or a lanyard to the filter.

In another embodiment of the present invention, a filter for use by a person is provided and includes: a mouthpiece for insertion into the user's mouth, the mouthpiece having a curvilinear mouthpiece shield including at least one mouthpiece hole, the mouthpiece having at least one bite wing and an exterior mouthpiece tube both coupled to the mouthpiece, the mouthpiece tube having proximal and distal ends with respect to the user, the proximal end of the mouthpiece tube coupled to the mouthpiece shield around the mouthpiece hole so as to permit air to flow through the mouthpiece hole and the mouthpiece tube, the mouthpiece shield configured for placement within the user's mouth between the user's teeth and the interior of the user's lips so that the mouthpiece is fixed in position in the user's mouth when the user's mouth is closed, the fixed position in the user's mouth resulting from the user's teeth clamping the bite wing and the user's lips covering the mouthpiece shield so as to seal around the mouthpiece at the external mouthpiece tube when the mouthpiece is inserted in the user's mouth; a valve tube structure having proximal and distal ends with respect to the user, the distal end of the tube structure formed in an oblong shape, the valve tube structure including a bend so that the proximal and distal ends are not collinear, the proximal end of the valve tube structure coupled to the distal end of the mouthpiece tube, the valve tube structure having a one-way valve with the tube so as to permit the flow of air into the valve tube structure from the distal end to the proximal end, the valve tube structure having a plurality of exhaust tubes coupled to the valve tube structure and disposed between the one-way valve and the proximal end of the valve tube structure, each of the exhaust tubes having proximal and distal ends with respect to the valve tube structure, the distal end of the exhaust valve exposed to the user's environment, each of the exhaust tubes having a one-way valve within the exhaust tube so as to permit the flow of air out to the user's environment from the proximal end of the exhaust tube structure to the distal end of the exhaust tube; a filter housing of rectangular prism shape, the filter having a flat connection surface and a filter surface, the connection surface having an oblong connection hole, the oblong connection hole matching in shape to the oblong shape of the distal end of the valve tube structure and sized for coupling of the distal end of the valve tube structure into the connection hole, the coupling including an o-ring for sealing the connection of the valve tube structure and the filter housing, the filter surface covering a substantial portion of at least one surface of the rectangular prism of the filter housing, the at least one surface constructed of a frame-like structure, the frame-like structure defining at least one filter hole, the filter hole permitting air to flow from the filter hole to the connection hole and into the valve tube structure; and a filter material disposed around a plurality of the surfaces of the rectangular prism on the outside of the filter housing, the filter material covering the filter hole and exposed to the user's environment.

In particular variations of this embodiment, the filter material is a cloth-like sheath, the filter material being affixed around an outside lateral surface of the filter housing; or the exhaust tube is proximate to the proximate end of the valve tube structure and the one-way valve within the valve tube structure is proximate to the exhaust tube; or the valve tube structure includes at least one flange containing a hole, the flange and hole used for securing one of a cap, a nosepiece or a lanyard to the filter.

### BRIEF DESCRIPTION OF THE SEVERAL VIEWS OF THE DRAWING(S)

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, in which:

FIG. 1 is a perspective view of the mouthheld filter according to one embodiment of the present invention;

FIG. 2 is a front view of the mouthheld filter of the present invention;

FIG. 3 is a back view of the mouthheld filter of the present invention;

FIG. 4 is a left side view of the mouthheld filter of the present invention;

FIG. 5 is a top view of the mouthheld filter of the present invention;

FIG. 6 is a bottom view of the mouthheld filter of the present invention;

FIG. 7 is a partial assembly diagram of the mouthheld filter according to one embodiment of the present invention;

FIG. 8 is a perspective view of the mouthheld filter housing according to one embodiment of the present invention;

FIG. 9 is a perspective view of the mouthheld filter illustrating one method of securing the present invention within the mouth of a user thereof;

FIG. 10 is a perspective view of the mouthheld filter showing the present invention including additional components thereof; and

FIG. 11 is a perspective view of the mouthheld filter according to another embodiment of the present invention.

To facilitate understanding, identical reference numerals have been used, where possible, to designate identical elements that are common to the figures.

### DETAILED DESCRIPTION OF THE INVENTION

To facilitate a clear understanding of the present invention, illustrative examples are provided herein which describe certain aspects of the invention. However, it is to be appreciated that these illustrations are not meant to limit the scope of the invention, and are provided herein to illustrate certain concepts associated with the invention.

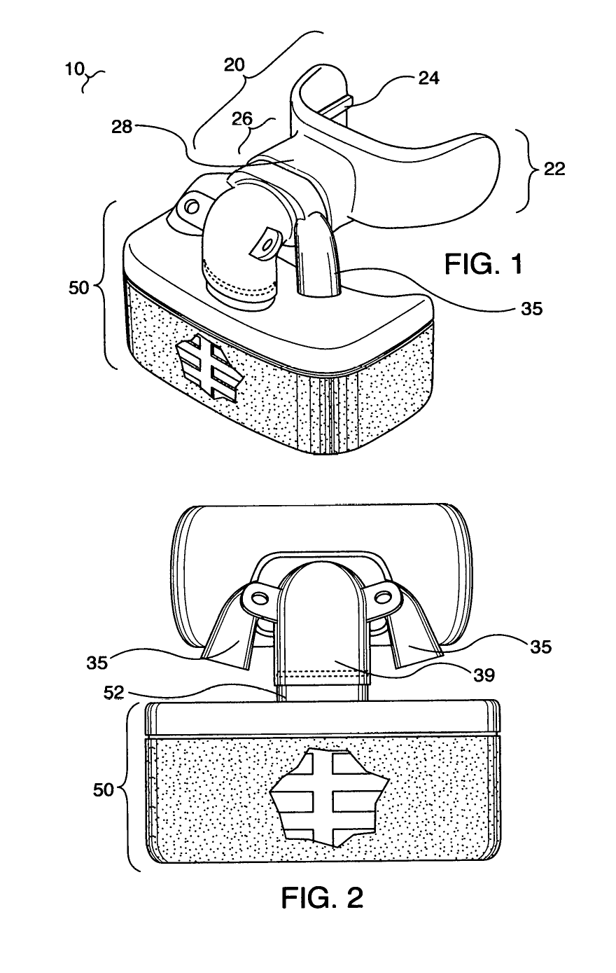

FIG. 1 shows a mouthheld filter apparatus according to one particularly preferred embodiment of the present invention. Mouthheld filter 10 includes three major sub assemblies: mouthpiece 20, valve tube structure 30 and filter housing 50.

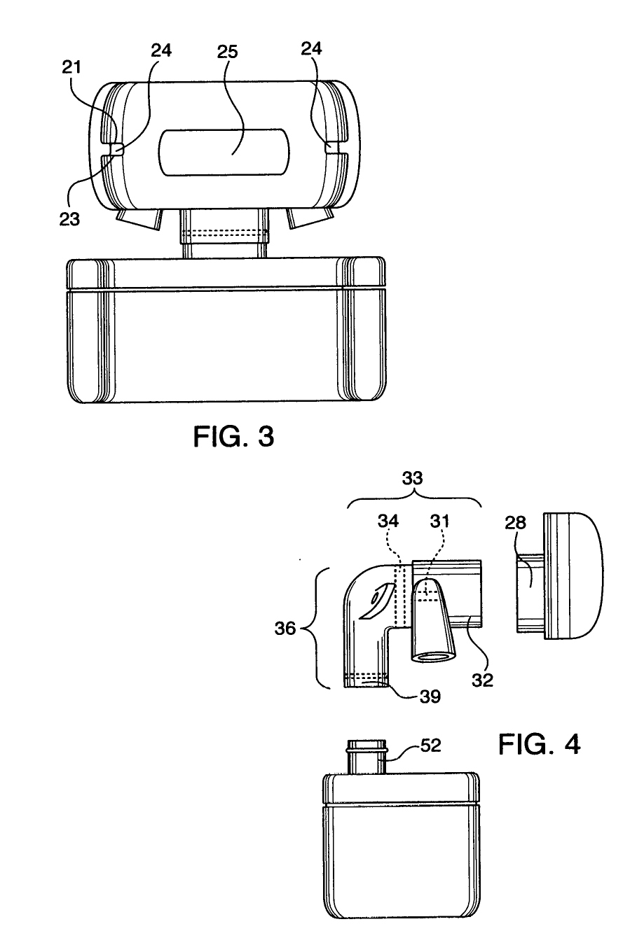

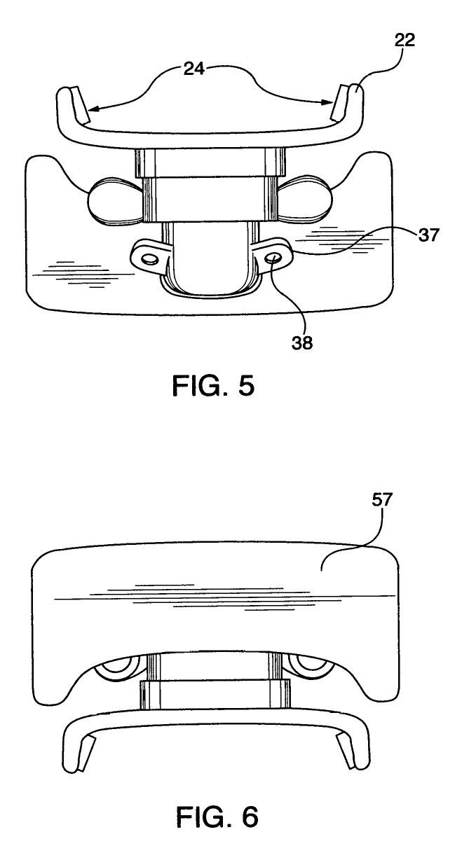

Mouthpiece 20 has curvilinear mouth shield 22 and bite wings 24. Mouth shield 22 is preferably made of molded plastic and has a generally flat and thin curvilinear profile as viewed from the top as shown in FIG. 5. Bite wings 24 are molded as part of the material comprising the mouth shield 22 and are disposed on the inner curved surface thereof. Mouthpiece tube 26 extends outward from mouthpiece 20 and away from the outer curved surface of mouth shield 22. As shown in FIGS. 1 and 4, hollow mouthpiece tube 26 is provided and attached on the outer curved surface of mouth shield 22 and projects straight out from the mouthpiece shield 22 ending at mouthpiece tube connector 28. Mouth shield hole 25, shown in FIG. 3, is provided on mouthpiece shield 22 and allows for air drawn from the connector end of mouthpiece tube 26 to pass from the connector end, through the hollow mouthpiece tube 26 and past mouthpiece shield 22. Vis-à-vis the user, the proximal end of the mouthpiece is at the mouth shield 22 and the distal end of the mouth piece is at the end of the mouthpiece tube 26 containing mouth piece tube connector 28.

In one particularly preferred embodiment, the entire mouthpiece 20 is a singular piece of molded plastic with the mouth shield 22, and mouthpiece tube 26, and mouth shield hole 25 forming a single, continuous entity. Injection molding of non-toxic plastic polyethylene or polyvinyl plastic material is one ideal method of manufacturing the mouthpiece 20 since it provides the rigidity needed to form a solid mouthpiece and provide a reliable coupling at the mouthpiece tube connector 28. Mouth shield hole may be preformed as part of the mouth shield 22, or alternatively, may be cut out of mouth shield 22, particularly if the mouth shield hole is dimensioned smaller than the diameter of mouthpiece tube 26. In other envisioned embodiments, the mouth piece 20, and particularly the mouth shield 22, is a composite of different structural elements. For, example, the outer rim (not shown) of the mouth shield 22 may be constructed of a plastic material more pliable than the precast polyethylene comprising the inner portion of the mouth shield 22. The more pliable outer mouth shield rim might be affixed to the mouthpiece shield 22 with glue or via a secondary mechanical means, for example a channeled rubber grommet (not shown) that is separately attached after formation of the remainder of the mouthpiece 20. The more pliable material may be of different plastic composition for ease and comfort, such as acrylic, acetate or vinyl.

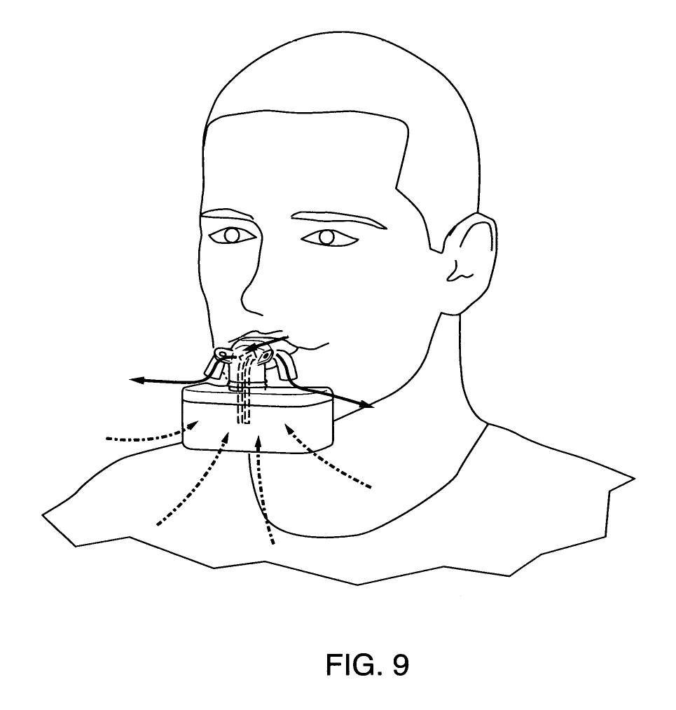

As shown in FIG. 9, the mouth shield 22 is shaped to fit within the closed mouth of the filter user, with the shield sitting between the user's teeth and the user's inner lips. The size of the mouthpiece shield is chosen to be comfortable for extended disposition of the filter mouth shield within the user's mouth. Bite wings 24 are sized and positioned on the inner curvilinear surface of the mouth shield such that the closed mouth of the user enables the user's teeth to clamp down on the upper and lower surfaces 21 and 23 of the bite wings and secure the entire filter in a fixed position within the user's mouth.

Referring back to FIGS. 1 and 4, valve tube structure 30 is provided and is generally cylindrical in its two portions, upper valve tube portion 33 and lower valve tube portion 36. The entire valve tube structure is also hollow and provides for the passage of air between upper valve tube connector 32 and lower valve tube connector 39. The upper valve tube portion is coupled to mouthpiece 20 and mouth tube connector 28 at upper valve tube connector 32. In the embodiment shown in FIG.4, the inner diameter of mouthpiece tube 26 and mouthpiece tube connector 28 is larger than the outer diameter of upper valve tube connector 32. Secure connection between the mouthpiece 20 and valve tube structure 30 may be made by any reliable connection means including but not limited to force-fit insertion, gluing, or the inclusion of ridges and grooves on the appropriate surfaces of the tube structures for snap-in connection. In any event, an airtight seal between the mouthpiece tube connector 28 and the upper valve tube connector 32 is desired so that all air flowing within the mouthheld filter 10 enters and exits at the appropriate portions of the filter as described below. Vis-à-vis the user, the proximal end of the valve tube structure is at the upper valve tube connector 32 and the distal end of the valve tube structure is at the lower valve tube connector 39.

As shown in FIG. 4, valve tube structure 30 is generally tubular and includes an approximate 90 degree bend from the horizontal first (upper) valve tube portion 33 to the downward extending second (lower) valve tube portion 36. One or more exhaust tubes 35 are included as part of the molded valve tube structure. Exhaust tube 35 is generally cylindrical and is connected to either the upper or lower valve tube portions, 33 and 36 respectively, such that the hollow portions of the exhaust tube is joined with the hollow portion of either the upper or lower valve tube portions, 33 and 36 respectively. Again, an airtight seal between the exhaust tube 35 and the upper or lower valve tube portion is desired so that all air flowing within the mouthheld filter 10 enters and exits at the appropriate portions of the filter as described below.

Valve tube structure 30 includes a one-way inhalation valve 34 which is disposed within the hollow inner portion valve tube structure 30. In one arrangement, the exhaust tube 35 is disposed on the upper valve tube portion 33 and the one-way inhalation valve is disposed within the hollow portion of lower valve tube portion 36. One-way inhalation valve 34 is oriented and functions in a manner in which the air inhaled by the user enters the lower valve tube portion 36 at lower valve tube connector 39, passes the one-way inhalation valve 34, progresses upwards through the lower and upper valve tube portions 36 and 33 and on to mouthpiece 20. One-way inhalation valve 34 precludes the passage of air in the reverse direction, i.e. from upper valve tube portion 33 out through lower valve tube connection 39. One-way inhalation valve may be composed of a simple flapper type valve structure and may be sited within the valve tube structure with glue or by insertion into preformed ridges therein.

The one or more exhaust tubes 35 include a one-way exhalation valve 31 which is disposed within the hollow inner portion of exhaust tube 35. In one arrangement, the exhaust tube 35 is disposed on the upper valve tube portion 33 and the one-way exhalation valve is disposed within the hollow portion of exhaust tube portion at approximately the half-way point along the length of the exhaust tube. One-way exhaust valve 31 is oriented and functions in a manner in which the air exhaled by the user enters the upper valve tube portion 33 at upper valve tube connector 32 from mouthpiece 20. The air then passes through upper valve tube portion 33 and past the one-way exhalation valve 31 downwards and out through exhaust tube 35 and to the exterior environment. One-way valve 34 precludes the passage of air in the reverse direction, i.e. from the exterior environment into exhaust tube 35 and into upper valve tube portion 33. Vis-à-vis the valve tube structure 30, the proximal end of the exhaust tube is at the valve tube structure and the distal end of the exhaust tube is at the end of the exhaust tube that exits to the environment. As with the one-way inhalation valve, one-way exhalation valve may be composed of a simple flapper type valve structure and may be sited within the exhaust tube structure with glue or by insertion into preformed ridges therein.

In one particularly preferred embodiment, the inhalation filter 34 and exhalation filter 31 are located as close as possible to the interface of the upper valve tube connector 32 and mouthpiece connector 28. Thus, exhaust tube 35 may be sited very close to the upper valve tube connector 32, exhalation valves 31 may be disposed high up within the exhalation tube, and inhalation valve 34 may be located just downstream from the exhaust tube junction on upper valve tube portion 33. This arrangement is to ensure that a minimal amount of air is trapped within the valve tube structure during operation.

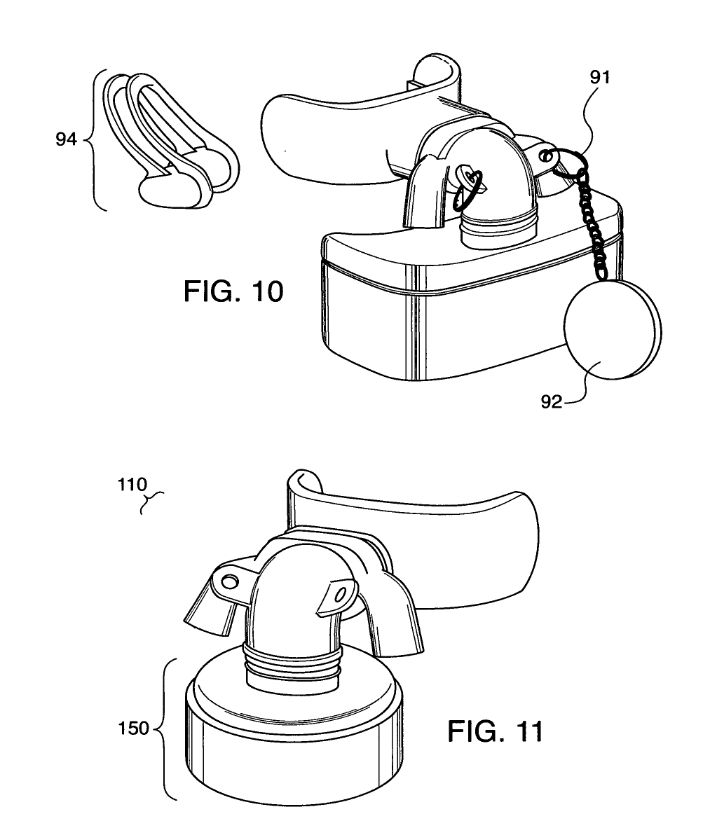

As show in FIG. 5 and as an additional design consideration, valve tube structure may include one or more flanges 37 that may be molded as part of the valve tube structure 30. Flange 37 further includes a hole 38 into which a connector ring 91 may be inserted as shown in FIG. 10. Connector ring 91 may be used to secure add-on components of the mouthheld filter such as a valve tube cap 92 or nose clips 94. Valve tube cap 92 may be used to cap off the lower valve tube connector 39 and protect the remaining portions of the mouthheld filter when the filter housing is removed therefrom. Finally, where two flanges 37 and associated holes 38 are included on the valve tube structure 30, a lanyard (not shown) may be attached for securing the mouthheld filter about the neck of the user.

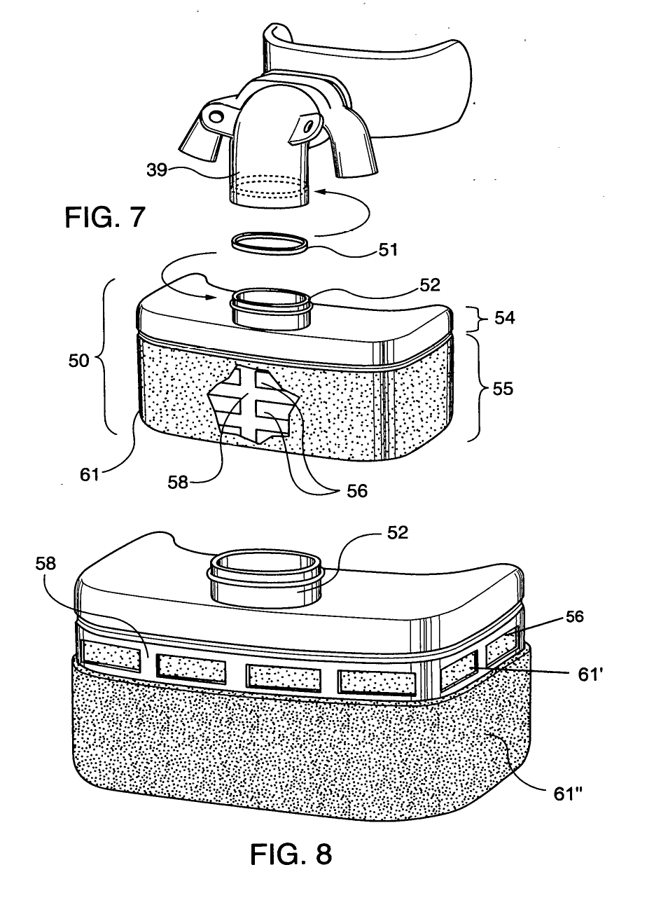

Referring to FIG. 7, filter housing 50 includes a first (upper) filter portion 54 and a second (lower) filter portion 55. Upper filter portion includes a connection surface 53 on which is formed a filter connector 52. Filter connector 52 is sized and designed to couple to lower valve tube connector 39. In the embodiment shown in FIG. 7, the outer diameter of filter connector 52 is smaller than the inner diameter of lower valve tube connector 39. Secure connection between the filter connector 52 and lower valve tube connector 39 may be made by any reliable connection means including, but not limited to, force-fit insertion, gluing, or the inclusion of ridges and grooves on the appropriate surfaces of the tube structures. In the particular arrangement shown in FIG. 7, annular, externally projecting ridges are provided on exterior surface of the filter connector 52 and annular indentations or grooves are provided on the interior surface of the lower valve tube connector 39 itself. O-ring 51 may be sized, configured and included to be slipped over the upper portion of the filter connector 52 between the hole therein and the annular ring thereon. O-ring 51 provides for a secure and airtight seal between the filter housing 50 and the valve tube structure 30 at lower valve tube connector 39 once the parts are snapped together. Such secure connection using said o-ring 51 ensures that all air flowing from the filter housing 50 into the valve tube structure 30 enters and exits at the appropriate portions of the filter as described below. In yet another embodiment (not shown), a threaded connection is created by molding threads with the lower valve tube portion and the exterior of the filter connector so that the two pieces may be screwed together. In this embodiment, the cross-sectional shapes of the lower valve tube connector 39 and the filter connector 52 may be made somewhat oval in shape so that a secure orientation may be provided in conjunction with threaded-connections on the two respective pieces when affixing the filter housing 50 to the valve tube structure 30.

Filter housing 50 is comprised of an upper filter portion 54 and a lower filter portion 55. These two portions may be sized and configured to fit together in any one of a number of connection orientations and constructions including but not limited to force-fit insertion, snap-fit coupling, gluing, or the inclusion of ridges and grooves on the appropriate surfaces of the two filter portions. In the embodiment shown in FIG. 7, the upper filter portion is a solid piece of plastic, with no holes other than that provided at the filter connector 52 allows air to access the interior volume of the upper filter portion 54. Lower filter portion 55 is also constructed of plastic, and includes at least one hole 56 within its casing structure. In the embodiment shown in FIG. 7, lower filter portion 55 comprises a solid bottom base 57, shown in FIG. 6, with the sides of the filter portion comprising a lattice structure 58. Lattice structure 58 may comprise any portion or portions of one or all of the lateral surfaces of lower filter portion 55. In operation, air from the external environment, enters mouthheld filter 10 through the holes 56 in the lower filter portion 55.

In most of the envisioned embodiments, lower filter portion 55 contains and/or supports the filter material and performs the actual filtering of the air inhaled from the environment. In one embodiment, shown in FIG. 8, lower filter portion 55 includes a filter material 61′ contained within the lower filter portion 55. A variety of known filter materials may be used here depending on the intended purposes and uses of the mouthheld filter. Among these are: activated carbon granules for removing polar organic gasses, e.g. from fire and combustion atmospheres, desiccants for removing moisture from the inhaled air, and/or catalyzation materials that convert carbon monoxide to carbon dioxide or other non-noxious gases. Electrostatically charged fiber filters may also be used, either within or around the inner or outer surfaces of the filter housing, for attracting particulate matter, e.g. from smoke. The holes 56 are sized appropriately to accommodate the filter material chosen and contained within the lower filter portion 55. In one envisioned embodiment, an inner screen may even be placed around the interior lateral surface of the lower filter portion 55 so as to contain the filter material within lower filter portion 55 and prevent the filter material from spilling out the holes 56 into the environment.

In one particularly preferred embodiment, shown in FIG. 8, an annular-shaped filter material 61″ is disposed around the outside lateral surface of lower filter portion 55. The filter material may be a cloth composite, a fine mesh screen, a high efficiency particulate arresting (NEPA) filter or an ultra low penetration air (ULPA) filter. The exterior filter is designed to have a diameter slightly smaller than the outer diameter of the lower filter portion 55 so that a slight stretching of the material is required to affix the filter material 61 around the lower filter portion 55. Further, the exterior filter material may be combined with any of the above-mentioned filter materials included within the lower filter portion 55 to achieve higher filtration capabilities.

The filter material will necessarily require periodic replacement and/or augmentation. In one embodiment, the upper and lower filter portions are separated and the filter material within the lower filter portion 55 is simply replaced. With respect to outer sheathing filters, the outer filter material (e.g. HEPA) may simply be removed and a new sheathing ffiter may be affixed about the exterior of lower filter portion 55. In more complete replacement systems, the entire filter housing 50 may be configured for replacement wherein the entire filter housing 50 is removed from the mouthheld filter and replaced. In another replacement option, the lower filter portion 55 may be disengaged from the upper filter portion 54 and new lower filter portion containing the filter material may be affixed to the overall mouthheld filter 10. Filter material costs and the manufacturing costs of the various portions of the mouthheld filter will necessarily govern the replacement options that the consumer market will support.

In operation and as shown in FIG. 9, the user of the mouthheld filter inhales air from the environment, shown in dashed lines, and enters the filter housing. The air then passes through the filter material(s), on either or both of the exterior and interior of the filter housing and then passes on to the interface of the filter connector 52 and lower valve connector 39. From there, the air passes upwards through the valve structure 30, past the one-way inhalation valve 34 and up to the interface of the upper valve tube connector 32 and mouthpiece tube connector 28. From there, the air passes through the mouthpiece tube 26 and through mouthpiece hole 25 and into the mouth and lungs of the user. As described above, one-way exhaust valve 31 is disposed and configured to prevent air from the environment near the end of exhaust tube(s) 35 from entering the valve tube structure when the pressure within the valve tube structure is less than the external, environmental air pressure.

Upon the user's exhaling, shown in solid lines, the air passes from the mouth and lungs of the user through mouthpiece hole 25 and into the mouthpiece tube 26. From there, the air passes downwards past the interface of the mouthpiece tube connector 28 and the upper valve tube connector 32 and through the valve tube structure 30. The air then passes on through the exhaust tube 35, the one-way exhalation valve 31 and out to the environment. As described above, one-way inhalation valve 34 is disposed and configured to prevent air exhaled by the user from exiting to the environment out through lower valve tube connector 39.

FIG. 11 shows a variant of the mouthheld filter 100 in which the filter housing 150 is cylindrical in shape. This filter works in the manner described above with the only physical exception being that the construction of the filter housing is of a different shape. Further, those of skill in the art will realize that each of the filter components described herein may be of a different geometric construction or orientation. For example, all the tubular structures, e.g. mouthpiece tube 26, valve tube structure 30 and filter connection 52 may be cylindrical or rectangular prisms or other equivalently hollow structures. In addition, other filters, and/or screens may be included within structural portions of the mouthheld filter other than the filter housing. For example, a fine mesh screen may line the inner curvilinear surface of the mouth shield 22 and covering mouth hole 25. In addition, other screens and filters may be included within the hollow structures of the mouthheld filter. Finally, the orientation of the mouthheld filter pieces may be rearranged to accommodate different uses or ergodynamic considerations. For example, valve tube structure may be angled to the sides or pointed up to place the filter in a different location relative to the user.

Although various embodiments, which incorporate the teachings of the present invention have been shown and described in detail herein, those skilled in the art can readily devise many other varied embodiments that still incorporate these teachings.

The invention claimed is:

1. A filter for use by a user comprising:
a mouthpiece for insertion into the user's mouth, said mouthpiece having a curvilinear mouthpiece shield including at least one mouthpiece hole and an exterior mouthpiece tube coupled to said mouthpiece, said mouthpiece tube having proximal and distal ends with respect to the user, said proximal end of said mouthpiece tube coupled to said mouthpiece shield around said mouthpiece hole so as to permit air to flow through said mouthpiece hole and said mouthpiece tube;
a valve tube structure having proximal and distal ends with respect to the user, said proximal end of said valve tube structure coupled to said distal end of said mouthpiece tube, said valve tube structure having a one-way valve within said tube so as to permit the flow of air into said valve tube structure from said distal end to said proximal end, said valve tube structure having an exhaust tube coupled to said valve tube structure and disposed between said one-way valve and said proximal end of said valve tube structure, said exhaust tube having proximal and distal ends with respect to said valve tube structure, said distal end of said exhaust valve exposed to the user's environment, said exhaust tube having a one-way valve within said exhaust tube so as to permit the flow of air out to the user's environment from said proximal end of said exhaust tube structure to said distal end of said exhaust tube; and
a filter housing having a connection surface and a filter surface, said connection surface having a connection hole, said connection hole coupled to said distal end of said valve tube structure, said filter surface having at least one filter hole, said filter hole permitting air to flow from said filter hole to said connection hole and into said valve tube structure, said filter housing supporting a filter material, said filter material covering said filter hole and exposed to the user's environment.

2. The filter of claim 1 wherein said filter material is a cloth-like sheath, said filter material being affixed around an outside lateral surface of said filter housing.

3. The filter of claim 1 wherein said cloth-like sheath is a high efficiency particulate arresting filter.

4. The filter of claim 1 wherein said filter housing includes a first filter portion containing said connection surface and a second filter portion containing said filter surface.

5. The filter of claim 4 wherein said second filter portion is removable from said first filter portion, said second filter portion being removed to replace said filter material.

6. The filter of claim 1 wherein said exhaust tube is proximate to said proximate end of said valve tube structure and said one-way valve within said valve tube structure is proximate to said exhaust tube.

7. The filter of claim 1 wherein said valve tube structure includes a plurality of said exhaust tubes, each disposed between said on-way valve and said proximal end of said valve tube structure.

8. The filter of claim 1 wherein said valve tube structure includes at least one flange containing a hole, said flange and hole used for securing one of a cap, a nosepiece or a lanyard to said filter.

9. A filter for use by a person comprising:
a mouthpiece for insertion into the user's mouth, said mouthpiece having a curvilinear mouthpiece shield including at least one mouthpiece hole, said mouthpiece having at least one bite wing and an exterior mouthpiece tube both coupled to said mouthpiece, said mouthpiece tube having proximal and distal ends with respect to the user, said proximal end of said mouthpiece tube coupled to said mouthpiece shield around said mouthpiece hole so as to permit air to flow through said mouthpiece hole and said mouthpiece tube, said mouthpiece shield configured for placement within the user's mouth between the user's teeth and the interior of the user's lips so that said mouthpiece is fixed in position in the user's mouth when the user's mouth is closed, the fixed position in the user's mouth resulting from the user's teeth clamping said bite wing and the user's lips covering said mouthpiece shield so as to seal around said mouthpiece at said external mouthpiece tube when said mouthpiece is inserted in the user's mouth;
a valve tube structure having proximal and distal ends with respect to the user, said distal end of said tube structure formed in an oblong shape, said valve tube structure including a bend so that said proximal and distal ends are not collinear, said proximal end of said valve tube structure coupled to said distal end of said mouthpiece tube, said valve tube structure having a one-way valve with said tube so as to permit the flow of air into said valve tube structure from said distal end to said proximal end, said valve tube structure having a plurality of exhaust tubes coupled to said valve tube structure and disposed between said one-way valve and said proximal end of said valve tube structure, each of said exhaust tubes having proximal and distal ends with respect to said valve tube structure, said distal end of said exhaust valve exposed to the user's environment, each of said exhaust tubes having a one-way valve within said exhaust tube so as to permit the flow of air out to the user's environment from said proximal end of said exhaust tube structure to said distal end of said exhaust tube;
a filter housing of rectangular prism shape, said filter having a flat connection surface and a filter surface, said connection surface having an oblong connection hole, said oblong connection hole matching in shape to said oblong shape of said distal end of said valve tube structure and sized for coupling of said distal end of said valve tube structure into said connection hole, said coupling including an o-ring for sealing said connection of said valve tube structure and said filter housing, said filter surface covering a substantial portion of at least one surface of said rectangular prism of said filter housing, said at least one surface constructed of a frame-like structure, said frame-like structure defining at least one filter hole, said filter hole permitting air to flow from said filter hole to said connection hole and into said valve tube structure; and
a filter material disposed around a plurality of said surfaces of said rectangular prism on the outside of said filter housing, said filter material covering said filter hole and exposed to the user's environment.

10. The filter of claim 9 wherein said filter material is a cloth-like sheath, said filter material being affixed around an outside lateral surface of said filter housing.

11. The filter of claim 9 wherein said cloth-like sheath is a high efficiency particulate arresting filter.

12. The filter of claim 9 wherein said filter housing includes a first filter portion containing said connection surface and a second filter portion containing said filter surface.

13. The filter of claim 12 wherein said second filter portion is removable from said first filter portion, said second filter portion being removed to replace said filter material.

14. The filter of claim 9 wherein said exhaust tube is proximate to said proximate end of said valve tube structure and said one-way valve within said valve tube structure is proximate to said exhaust tube.

15. The filter of claim 9 wherein said valve tube structure includes at least one flange containing a hole, said flange and hole used for securing one of a cap, a nosepiece or a lanyard to said filter.
